(19) United States
(12) Patent Application Publication
(10) Pub. No.: US 2010/0026596 A1
(43) Pub. Date: Feb. 4, 2010

(54) ANTENNA DEVICE

(75) Inventors: Masaki Nishio, Tokyo (JP); Yukako Tsutsumi, Yokohama-Shi (JP); Takayoshi Ito, Yokohama-Shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/505,710

(22) Filed: Jul. 20, 2009

(30) Foreign Application Priority Data
Jul. 31, 2008 (JP) 2008-198038

(51) Int. Cl. H01Q 1/00; H01Q 23/00

(52) U.S. Cl. 343/745

(57) ABSTRACT

The antenna device includes a ground plane 101; a first radiating element 103 having a first conductive element 103a and a second conductive element 103b; a second radiating element 104 having a third conductive element 104a and a fourth conductive element 104b; a variable capacity element 105 arranged between the first conductive element and the third conductive element; and a capacity controller 108 to control the capacity of the variable capacity element.

### CROSS REFERENCE TO RELATED APPLICATIONS

This application is based upon and claims the benefit of priority from the prior Japanese Patent Application No. 2008-198038, filed on Jul. 31, 2008, the entire contents of which are incorporated herein by reference.

### BACKGROUND OF THE INVENTION

1. Field of the Invention

The present invention relates to an antenna device, and relates to, for example, a tunable antenna having a variable capacity element.

2. Related Art

JP-A 2005-150937 (Kokai) and JP-A 2005-210568 (Kokai) disclose a tunable antenna in which a low profile antenna such as an inverted-F antenna and a ground plane are connected each other through a variable capacity element to change the operating frequency of the antenna by changing the capacity value of the variable capacity element.

However, the above tunable antenna requires a large range of capacity variable ratio from a small capacity value to a large capacity value to change the operating frequency, which leads to a problem that the loss of the variable capacity element becomes large in the operation at a low frequency since high-frequency current easily flows due to a large capacity value.

Further, when a plate-like element is used, the operation over a broad band can be achieved with high efficiency. However, in the end, the required capacity variable width becomes large and the loss of the element becomes large in the operation at a low frequency.

### SUMMARY OF THE INVENTION

According to an aspect of the present invention, there is provided with an antenna device comprising: a ground plane, a first radiating element, a second radiating element, a variable capacity element and a capacity controller. The first radiating element has a first conductive element and a second conductive element. A one end of the second conductive element is connected to a one end of the first conductive element and the other end of the second conductive element is connected to the ground plane. The second radiating element has a third conductive element and a fourth conductive element. A one end of the third conductive element faces the other end of the first conductive element, and a one end of the fourth conductive element is connected to the other end of the third conductive element and the other end of the fourth conductive is connected to the ground plane. A one end of the variable capacity element is connected to the other end of the first conductive element and the other end of the variable capacity element is connected the one end of the third conductive element. A capacity controller controls the capacity of the variable capacity element.

### BRIEF DESCRIPTION OF THE DRAWINGS

FIG. 1 is a diagram showing a schematic structure of an antenna device according to an embodiment of the present invention.

FIG. 2 is a diagram showing the current distribution on a suggested antenna.

FIG. 3 is a diagram showing a schematic structure of the antenna device according to the embodiment of the present invention.

FIG. 4 is a diagram showing a schematic structure of a conventional inverted-F antenna with a variable capacitor.

FIG. 5 is a diagram showing the relationship between a capacity value and matching frequency in the antenna device of each of FIGS. 3 and 4.

FIG. 6 is a diagram showing the relationship between the capacity value and gross efficiency in the antenna device of FIG. 3.

FIG. 7 is a diagram showing the relationship between the capacity value and gross efficiency in the inverted-F antenna with the variable capacitor of FIG. 4.

FIG. 8 is a diagram showing the change in radiation efficiency when the installation position of a variable capacity element is changed in the antenna device of FIG. 3.

FIG. 9 is a diagram showing how the distance between an antenna element and a passive element is changed.

FIG. 10 is a diagram showing the change in radiation efficiency when the distance between the antenna element and the passive element is changed.

FIG. 11 is a diagram showing a schematic structure of an antenna device according to another embodiment of the present invention.

FIG. 12 is a diagram showing an example in which the antenna element and the passive element are formed to be plate-like.

FIG. 13 is a diagram showing an example in which the antenna device of FIG. 1 is mounted on a board.

FIG. 14 is a diagram showing an example in which the antenna device of FIG. 11 is mounted on the board.

FIG. 15 is a diagram showing a schematic structure of an antenna device according to further another embodiment of the present invention.

FIG. 16 is a diagram showing a schematic structure of an antenna device according to further another embodiment of the present invention.

### DETAILED DESCRIPTION OF THE INVENTION

Embodiments according to the present invention will now be explained with reference to the accompanying drawings.

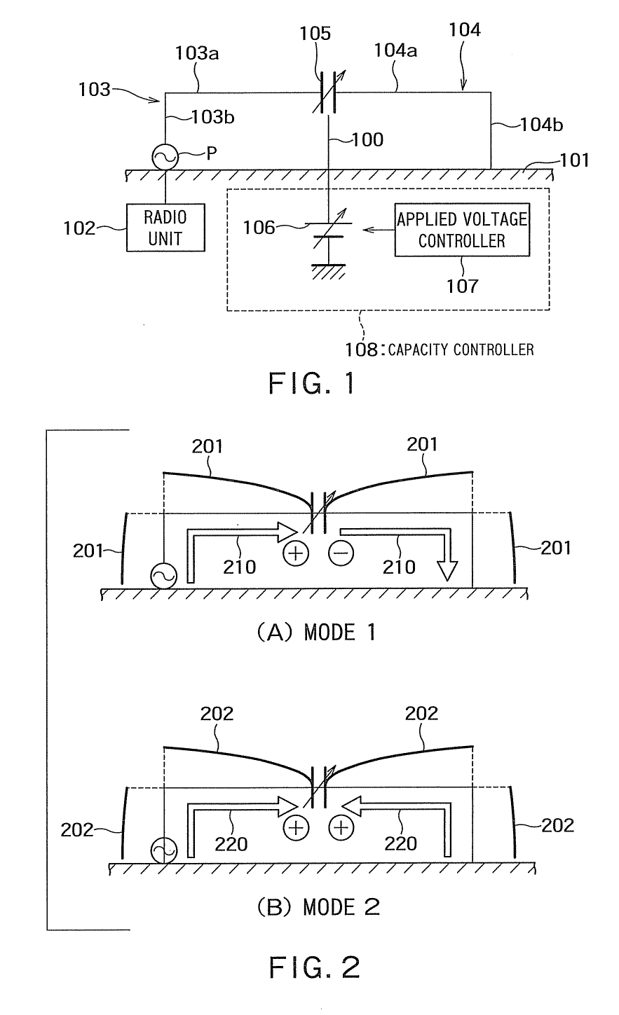

FIG. 1 is a diagram showing a schematic structure of an antenna device according to a first embodiment of the present invention.

The antenna device includes: a ground plane 101 of a radio communication terminal; an inverted L-shaped antenna element (first radiating element) 103 having a one end serving as an open end and the other end connected to a radio unit 102 through a feeding point P; an inverted L-shaped passive element (second radiating element) 104 having a one end facing the one end of the inverted L-shaped antenna element 103 and the other end connected to the ground plane 101; a variable capacity element 105 arranged between the inverted L-shaped antenna element 103 and inverted L-shaped passive element 104; and a capacity controller 108 to control the capacity of the variable capacity element 105.

The inverted L-shaped antenna element 103 includes a first conductive element 103a and a second conductive element 103b, the second conductive element 103b having a one end connected to a one end of the first conductive element 103a and the other end connected to the feeding point P arranged on the ground plane. The first conductive element 103a is arranged approximately in parallel to the surface of the ground plane 101, while the second conductive element 103b is arranged approximately perpendicular to the surface of the ground plane 101. Here, the connection between the first conductive element 103a and the second conductive element 103b means that the first conductive element and the second conductive element are electrically connected, and it does not matter whether or not the first conductive element and the second conductive element are separated from each other. That is, the first conductive element and the second conductive element can be connected to each other by physically connecting these elements through soldering etc. or by forming these elements into one conductive element. As stated above, the first and second conductive elements can be separated from or integrated with each other. By integrating the first and second conductive elements with each other, the number of processes to manufacture the radiating element can be decreased compared to the case where the first conductive element and the second conductive element are physically connected.

The inverted L-shaped passive element 104 includes a third conductive element 104a having a one end facing the other end of the first conductive element 103a and a fourth conductive element 104b having a one end connected to the other end of the third conductive element 104a and the other end connected to the ground plane 101. The third conductive element 104a is arranged approximately in parallel to the surface of the ground plane 101, while the fourth conductive element 104b is arranged approximately perpendicular to the surface of the ground plane 101. As in the first conductive element 103a and the second conductive element 103b, the third conductive element and the fourth conductive element can be separated from or integrated with each other.

The capacity controller 108 includes a voltage supplier 106 to supply hold voltage as a control signal to the variable capacity element 105 through a control line 100, and an applied voltage controller 107 to control the hold voltage of the voltage supplier 106.

The variable capacity element 105 has a terminal connected to the end of the inverted L-shaped antenna element 103, a terminal connected to the end of the passive element 104, and a terminal to receive the control signal from the voltage supplier 106 through the control line 100 to form the capacity depending on the received control signal. A MEMS capacitor, for example, can be used as the variable capacity element 105. By using a MEMS element, the effect of low strain and low loss can be achieved.

With the above structure, the capacity variable width required to operate the antenna in a desired frequency band becomes smaller compared to the conventional antenna in which the variable capacity element is connected between the end of the inverted-F antenna and the ground plane. Accordingly, the capacity value can be restrained to be smaller than that of the conventional antenna in the operation at a low frequency, by which high-frequency current hardly flows through the variable capacity element and the loss of the variable capacity element can be decreased. Hereinafter, this antenna device will be explained in more detail.

FIG. 2 is a diagram showing two resonance modes achieved by the antenna device of FIG. 1.

When the ends of the antenna element and the passive element are connected through the capacity element as in the antenna device of FIG. 1, two resonance modes occur. FIG. 2(A) shows a first mode 1, while FIG. 2(B) shows a second mode 2.

Each of a symbol 210 in FIG. 2(A) and a symbol 220 in FIG. 2(B) represents the direction of the electric current flowing through the antenna at a certain moment, while each of a symbol 201 in FIG. 2(A) and a symbol 202 in FIG. 2(B) represents the current amplitude of the antenna. The direction of electric current in the resonance mode 1 and that in the resonance mode 2 are different from each other. The mode 1 occurs at a lower frequency than the mode 2.

The present embodiment is focused on the mode 1 of FIG. 2(A), and the antenna device is operated in the mode 1. In the mode 1, as seen from the direction of electric current, a large potential difference occurs between the both ends of the variable capacity element therebetween. Accordingly, the influence of the capacity value of the variable capacity element exerted on the resonance frequency of the antenna becomes large, by which the resonance frequency can be largely changed by a small capacity change. On the other hand, in the mode 2 of FIG. 2(B), the potential difference between the both ends of the variable capacity element therebetween becomes small, by which the frequency changes small when the capacity value is changed.

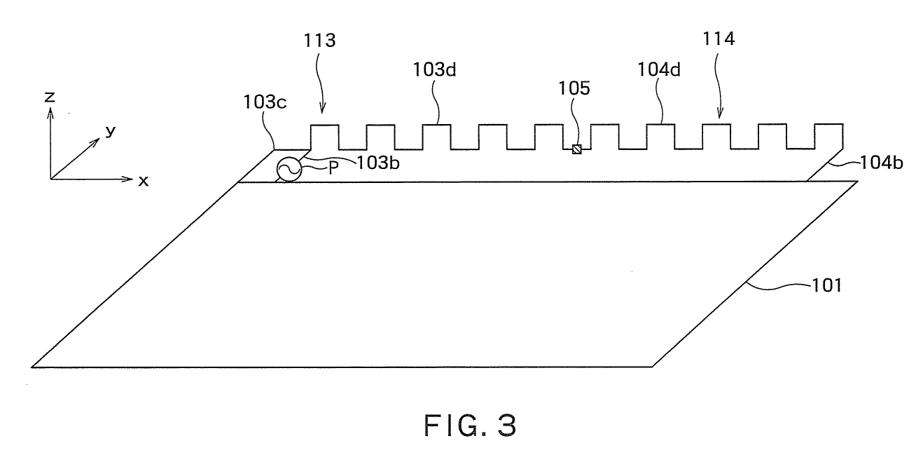

Hereinafter, referring to FIGS. 3 to 7, the superiority of the antenna according to the present embodiment will be explained compared to the conventional antenna. Note that the antenna according to the present embodiment is operated in the mode 1.

In FIG. 3, the antenna according to the present embodiment is arranged along the long side of the ground plane having a length of 65 mm and a width of 110 mm. In this antenna, the one end of the first conductive element of the antenna element 103 of FIG. 1 is connected to the ground plane 101 through a fifth conductive element 103c, and the first conductive element 103a of the antenna element and the third conductive element 104a of the passive element are formed to have a meander form to serve as meander elements 103d and 104d, respectively. An antenna element 113 is formed of the elements 103b, 103c, and 103d, while a passive element 114 is formed of the elements 104b and 104d. Each of the meander elements 103d and 104d meanders in one direction. The antenna of FIG. 3 rises up in the position 8 mm apart from the long side of the ground plane 101 in the +y direction, has a thickness 5 of mm from the surface of the ground plane in the +z direction, and is folded every 5 mm. At this time, the variable capacity element 105 is arranged at the center of the meander form so that the antenna element 113 and the passive element 114 operate at approximately the same frequency.

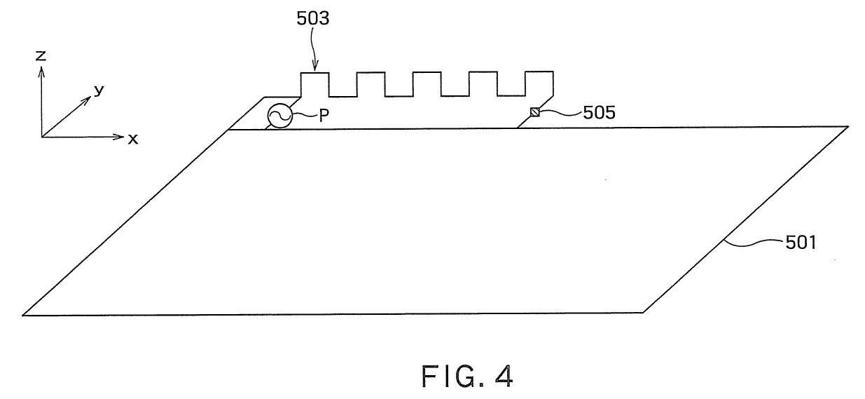

As in FIG. 3, a conventional inverted-F antenna 503 of FIG. 4 is arranged in the position 8 mm apart from the long side of the ground plane 101 in the +y direction to have a thickness of 5 mm from the surface of the ground plane in the +z direction, and the end of the inverted-F antenna and the ground plane 501 are connected through the variable capacity element 505. The antenna length of the inverted-F antenna is approximately a half of that of the antenna of FIG. 3.

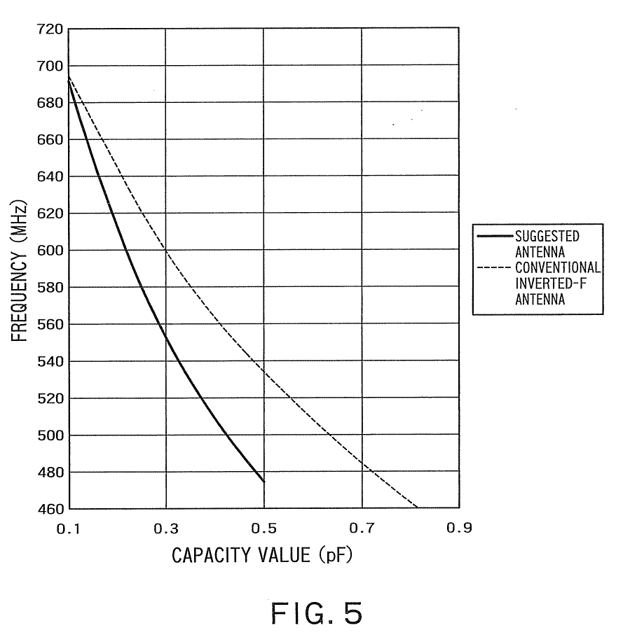

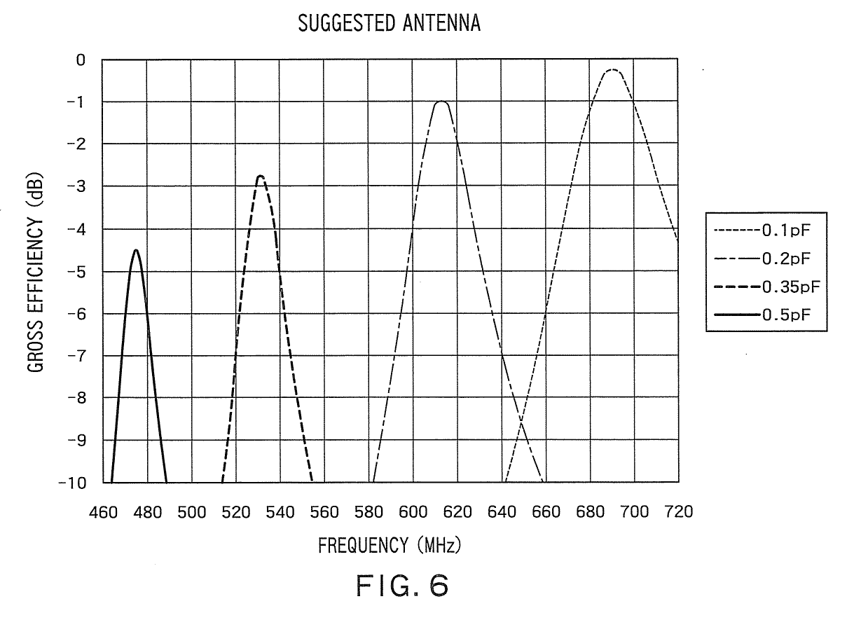

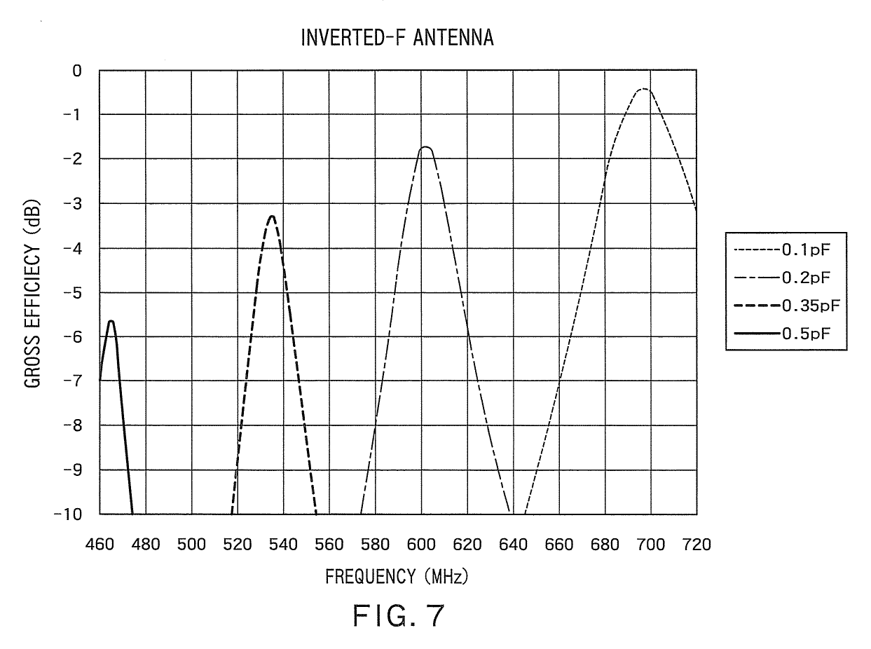

FIG. 5 is a diagram showing a comparison result of the antenna of FIG. 3 and the antenna of FIG. 4 to judge how the best frequency matching with 50 O changes when the capacity values of the variable capacity element 105 and the variable capacity element 505 is made larger than 0.1 pF. Further, FIG. 6 shows the relationship between the capacity value and gross efficiency of a suggested antenna, while FIG. 7 shows that of the conventional inverted-F antenna. Here, the gross efficiency means the combination of a power transmission coefficient and radiation efficiency. Each of the variable capacity elements 105 and 505 has a resistance component of 2 O.

As shown in FIG. 5, since the variable capacity element 105 has a large influence, the suggested antenna of FIG. 3 makes it possible to change the frequency largely by a small capacity change compared to the conventional the inverted-F antenna of FIG. 4. Further, the comparison between FIGS. 6 and 7 shows that high efficiency can be achieved particularly on the low frequency side in the suggested antenna.

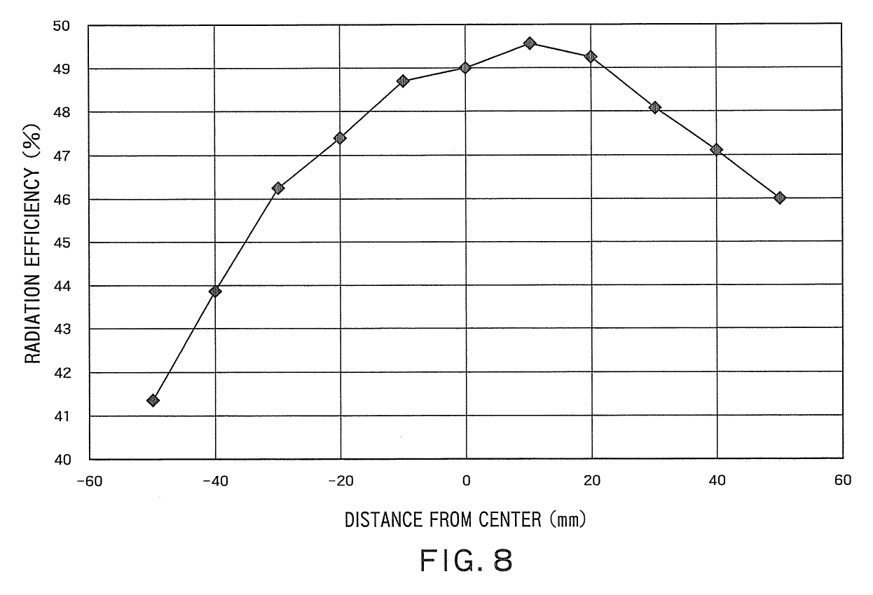

FIG. 8 shows the change in the radiation efficiency at a matching frequency in the meander-shaped suggested antenna of FIG. 3 when the installation position of the variable capacity element having 0.5 pF is shifted from the center of the meander every 10 mm. The distance from the center in the positive direction corresponds to the passive element side (the X-axis direction in FIG. 3), while the distance from the center in the negative direction corresponds to the antenna element side (the direction opposite to the X-axis). FIG. 8 shows that a suitable radiation efficiency can be achieved when the variable capacity element is arranged in the position nearly the center of the meander form. This is because the antenna element and the passive element have approximately the same resonance frequency at that time and a node of electric current is formed around the center, and thus the loss of the variable capacity element is decreased.

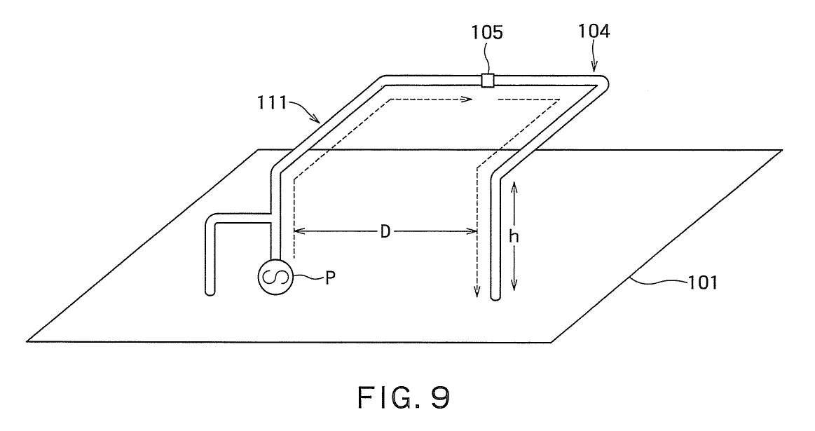

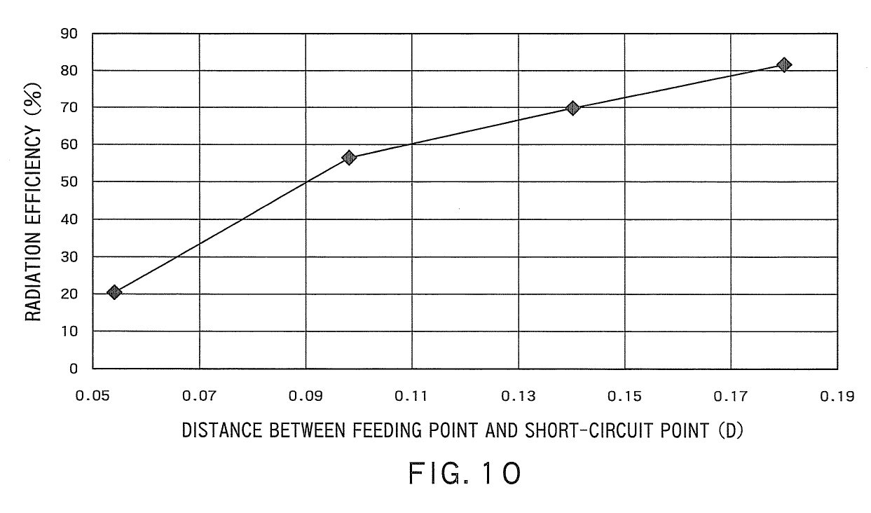

FIG. 10 shows the change in radiation efficiency at a matching frequency when, as shown in FIG. 9, distance D between the feeding point and a short-circuit point is shortened so that the horizontal portions of the antenna element and the passive element which are level with the ground plane 101 are in parallel to each other. Note that, in the suggested antenna in this case, the inverted L-shaped antenna element 103 of the suggested antenna of FIG. 1 is replaced with an inverted F-shaped antenna element 111, and the capacity value of the variable capacity element 105 is set to be 0.1 pF. Further, a dotted line arrow in FIG. 9 shows the direction of current flow.

As seen from FIG. 10, the longer the distance D becomes, the larger the radiation efficiency becomes. This is because, in the resonance mode 1 (see FIG. 2(A)) used in the suggested antenna, the radiation efficiency deteriorates due to the electric current counteracted between the horizontal portions of the antenna element and the passive element and between the vertical portions (see symbol h) of the antenna element and the passive element when the both elements are made closer to each other as shown in FIG. 9. Therefore, it is desirable that the distance D is long, which means it is desirable that the first conductive element 103a of the inverted L-shaped antenna element 103 and the third conductive element 104a of the passive element 104 are linearly formed as shown in FIG. 1. Further, as shown in FIG. 3, it is desirable that each of the meander elements 103d and 104d is formed to meander in one direction.

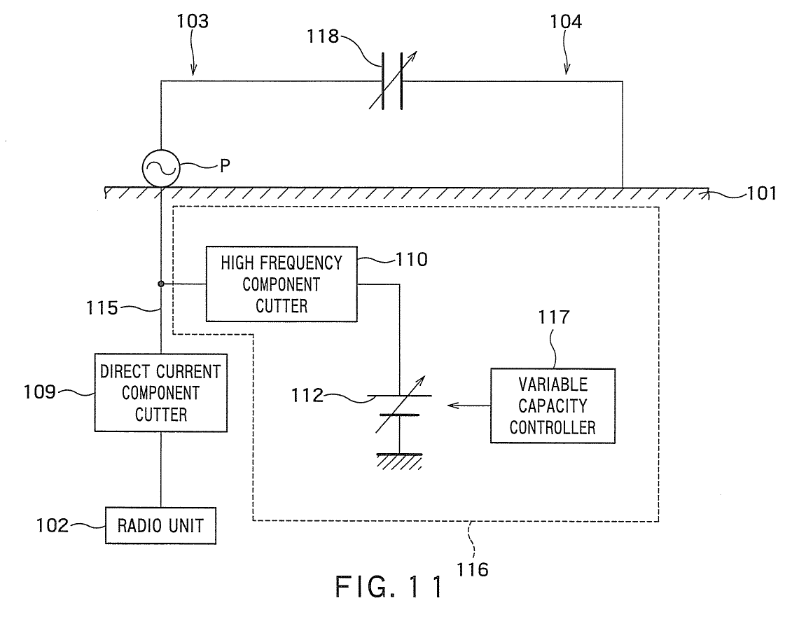

FIG. 11 is a diagram showing a schematic structure of an antenna device according to another embodiment of the present invention.

The variable capacity element 118 has a first terminal connected to the end of the antenna element 103 and a second terminal connected to the end of the passive element 104, and forms capacity depending on the voltage applied between the two terminals. A diode, for example, can be used as the variable capacity element 118. Concretely, voltage is applied between the both terminals of the variable capacity element 118 by applying voltage between a signal line 115 of the antenna element and the ground plane 101. Accordingly, peripheral parts of the antenna element can be easily manufactured.

A direct current component cutter 109 is arranged on the signal line 115 between the feeding point P and the radio unit 102 to cut the direct current component of a high frequency signal generated by the radio unit 102.

A direct current component supplier 116 is arranged to supply a signal of the direct current component to the signal line 115. The direct current component supplier 116 has a voltage supplier 112 to hold voltage and output the hold voltage, a variable capacity controller 117 to set the voltage of the voltage supplier 112, and a high frequency component cutter 110 to extract the direct current component by cutting the high frequency component from the signal output from the voltage supplier 112 to output the direct current component to the signal line 115.

The high frequency signal output from the direct current component cutter 109 is combined with the direct current component output from the high frequency component cutter 110 to be supplied to the feeding point P. Accordingly, the first terminal of the variable capacity element 118 is connected to the potential of the direct current component, while the second terminal of the variable capacity element 118 is connected to the ground potential (the ground plane 101) through the passive element 104, by which the voltage depending on the difference between the both potentials is applied between the first and second terminals.

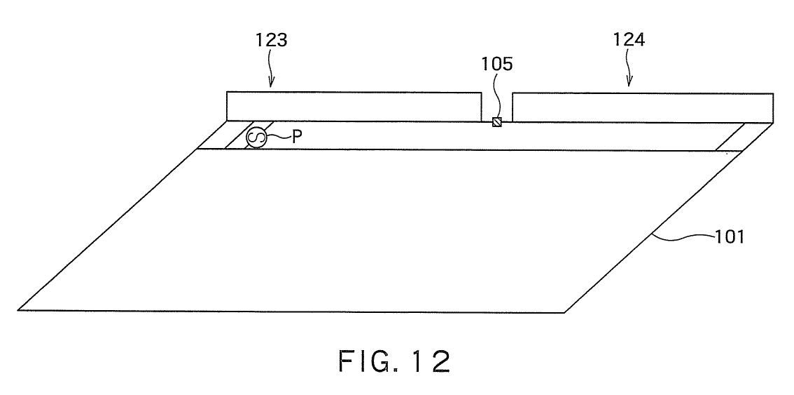

In the suggested antenna as shown in FIGS. 1, 3, and 11, each of the antenna element and the passive element is formed of a linear element. However, each of the antenna element 123 and the passive element 124 can be formed of an element having a plate form as shown in FIG. 12, for example, which makes it possible to make the antenna operate over a broad band.

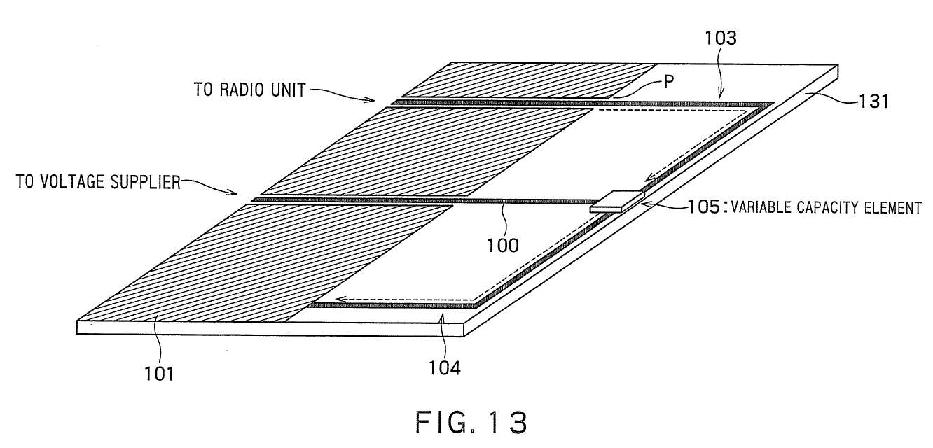

FIG. 13 is a perspective diagram showing an example in which the suggested antenna of FIG. 1 is mounted on a board 131. The same components as those in FIG. 1 are given the same symbols, and the explanation thereof will be omitted. A dotted line arrow in FIG. 13 shows the direction of current flow.

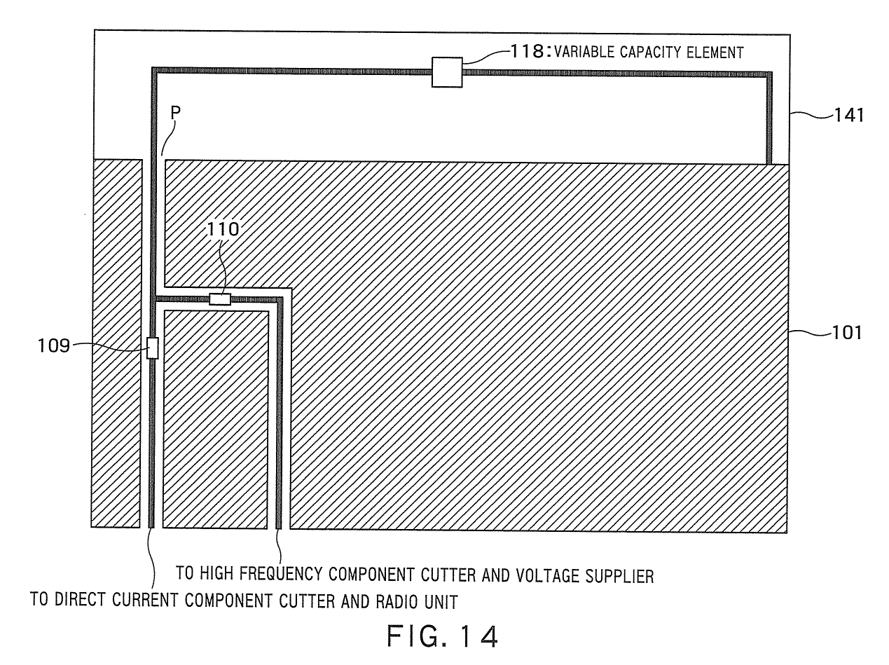

The control line 100 to supply the control signal to the variable capacity element 105 is arranged in the position where the distance between the control line 100 and the antenna element 103 and the distance between the control line 100 and the passive element 104 are approximately the same. Accordingly, the influence exerted on the control line 100 by the antenna element 103 and the influence exerted on the control line 100 by the passive element 104 are counteracted with each other, by which the influence exerted on the control line 100 can be decreased. As in FIG. 13, the suggested antenna of FIG. 11 can be mounted on the board. FIG. 14 is a plane view showing a structural example of this case. The same components as those in FIG. 11 are given the same symbols, and the detailed explanation thereof will be omitted. A symbol 141 represents a board.

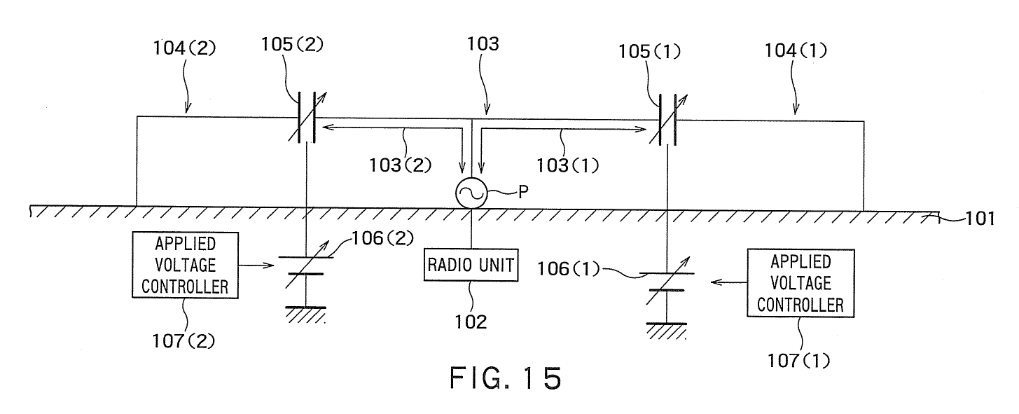

FIG. 15 is a diagram showing a schematic structure of an antenna device according to further another embodiment of the present invention.

The antenna device of FIG. 15 has two antenna devices of FIG. 1 which operate at the frequencies different from each other and are symmetrically arranged. In FIG. 15, the antenna element 103(2) and the passive element 104(2) in the antenna device on the left side are shorter than the antenna element 103(1) and the passive element 104(1) in the antenna device on the right side, respectively.

The antenna element 103(2) corresponds to a third radiating element, for example, while the passive element 104(2) corresponds to a fourth radiating element, for example. The variable capacity element 105(2) corresponds to a second variable capacity element, for example. The applied voltage controller 107(2) and the voltage supplier 106(2) form a second capacity controller, for example.

An element portion which is connected to the feeding point P and is perpendicular to the ground plane 101 is shared between the antenna element 103(2) and the antenna element 103(1). In the example shown in FIG. 15, the branch point of the element portion perpendicular to the ground plane 101 is arranged at the same height as the variable capacity elements 105(1) and 105(2). However, the element portion can branch at a lower position. With the structure as shown in FIG. 15, it is possible to realize an antenna which operates at a plurality of frequencies at the same time with a high efficiency.

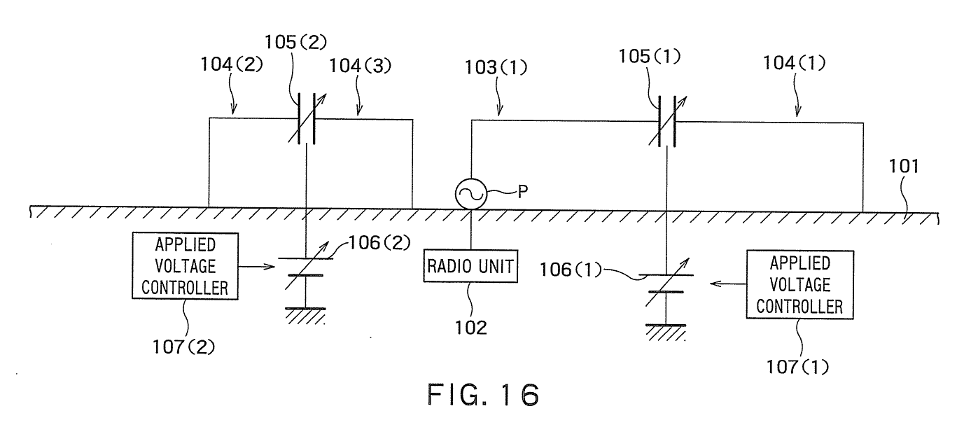

FIG. 16 is a diagram showing a schematic structure of an antenna device according to further another embodiment of the present invention.

The antenna device of FIG. 1 (on the right side of the sheet) and the antenna device having the passive element instead of the antenna element of the antenna device of FIG. 1 (on the left side of the sheet) according to the one embodiment of the present invention are arranged with a predetermined distance therebetween.

The antenna device on the left side includes two of the passive elements 104(3) and 104(2), which are shorter than the antenna elements 103(1) and the passive element 104(1) of the antenna device on the right side, respectively. Similarly to the antenna device on the right side, the antenna device on the left side has two of the resonance modes 1 and 2, and operates in the resonance mode 1. With the structure as stated above, the degrees of freedom in design can be increased, and the operation at a plurality of resonance frequencies in a broad band can be easily achieved, for example. Note that the effect of the present invention can also be achieved when the antenna device on the left side is arranged apart from a conventional antenna device instead of the antenna device of FIG. 1. Further, it is also possible to make changes as shown in FIGS. 3, 12, and 15 to the antenna device on the left side, as in the antenna device of FIG. 1.

The suggested antenna explained hereinbefore can operate as an antenna to receive terrestrial digital broadcasting by being mounted in a mobile terminal, a notebook PC, an FPD (Flat Panel Display), and a small AV terminal.

The present invention is not limited to the exact embodiments described above and can be embodied with its components modified in an implementation phase without departing from the scope of the invention. Also, arbitrary combinations of the components disclosed in the above-described embodiments can form various inventions. For example, some of the all components shown in the embodiments may be omitted. Furthermore, components from different embodiments may be combined as appropriate.

What is claimed is:

1. An antenna device comprising:
a ground plane;
a first radiating element having a first conductive element and a second conductive element, a one end of the second conductive element being connected to a one end of the first conductive element and the other end of the second conductive element being connected to the ground plane;
a second radiating element having a third conductive element and a fourth conductive element, a one end of the third conductive element facing the other end of the first conductive element, and a one end of the fourth conductive element being connected to the other end of the third conductive element and the other end of the fourth conductive being connected to the ground plane;
a variable capacity element whose one end is connected to the other end of the first conductive element and other end is connected the one end of the third conductive element; and
a capacity controller to control capacity of the variable capacity element.

2. The antenna device according to claim 1, wherein the other end of the second conductive element is connected to a feeding point on the ground plane.

3. The antenna device according to claim 1, wherein each of the first conductive element and the third conductive element has a linear form.

4. The antenna device according to claim 1, wherein each of the first conductive element and the third conductive element has a meander form.

5. The antenna device according to claim 1, wherein a resonance frequency of the first radiating element is approximately same as that of the second radiating element.

6. The antenna device according to claim 1, wherein the first radiating element further includes a fifth conductive element whose one end is connected to the one end of the first conductive element and other end is connected to the ground plane such that the one end of the first conductive element is short-circuited to the ground plane.

7. The antenna device according to claim 1, wherein each of the first to fourth conductive elements is a linear element or a plate-like element.

8. The antenna device according to claim 1 further comprising a control line arranged between the capacity controller and the variable capacity element, wherein
a distance between the second conductive element and the control line is approximately same as that between the fourth conductive element and the control line.

9. The antenna device according to claim 8, wherein the variable capacity element is a MEMS capacitor.

10. The antenna device according to claim 1, wherein
the variable capacity element has a first terminal connected to the other end of the first conductive element and a second terminal connected to the one end of the third conductive element and forms the capacity depending on an applied voltage between the first and second terminals, and
the capacity controller controls the applied voltage and thereby controls the capacity of the variable capacity element.

11. The antenna device according to claim 10, wherein the variable capacity element is a diode.

12. The antenna device according to claim 1, further comprising:
a sixth linear element having a one end connected to the one end of the first conductive element;
a seventh conductive element having a one end facing the other end of the sixth conductive element;
a eighth conductive element having a one end connected to the other end of the seventh conductive element and an other end connected to the ground plane;
a second variable capacity element whose one end is connected to the other end of the sixth conductive element and other end is connected to the one end of the seventh conductive element; and
a second capacity controller to control capacity of the second variable capacity element, wherein
a third radiating element is comprised of the sixth conductive element and the second conductive element, and
a fourth radiating element is comprised of the seventh conductive element and the eighth conductive element.
